(19) United States
(12) Patent Application Publication
(10) Pub. No.: US 2026/0060470 A1
(43) Pub. Date: Mar. 5, 2026

(54) SELF-EMPTYING BEVERAGE OUTLET AND BEVERAGE PREPERATION APPLIANCE HAVING A SELF-EMPTYING BEVERAGE OUTLET

(71) Applicant: BSH HAUSGERÄTE GMBH, München (DE)

(72) Inventors: Bernhard GERL, Traunstein (DE); Manuel HENZ, Laufen (DE); Christian HASLACHER, Thalgau (AT); Vanessa TAUSCH, Übersee (DE)

(21) Appl. No.: 19/318,634

(22) Filed: Sep. 4, 2025

(30) Foreign Application Priority Data
Sep. 4, 2024 (DE) 102024208415.8

(51) Int. Cl. A47J 31/46

(52) U.S. Cl. CPC A47J 31/46

(57) ABSTRACT

A beverage outlet of a beverage preparation appliance for household purposes contains an inlet coming from a preparation apparatus. A bifurcation of the inlet faces away from the preparation apparatus in the direction of flow and at least two individual outlets are provided and connect to the bifurcation in the direction of flow. At least one first individual outlet differs from the other, a second individual outlet or from the remaining individual outlets in its dimensions, so that all individual outlets are automatically completely emptied during operation. Preferably a beverage preparation appliance is fitted with such a beverage outlet.

### CROSS-REFERENCE TO RELATED APPLICATION

This application claims the priority, under 35 U.S.C. § 119, of German Patent Application DE 102024208415.8, filed September 4, 2024; the prior application is herewith incorporated by reference in its entirety.

### FIELD AND BACKGROUND OF THE INVENTION

The invention relates to a beverage outlet of a beverage preparation appliance for household purposes, in particular a fully automatic coffee machine, having an inlet coming from a preparation apparatus (“appliance-side”), having a bifurcation of the inlet facing away from the preparation apparatus in the direction of flow, and having at least two individual outlets adjoining the bifurcation in the direction of flow. The invention also relates to a beverage preparation appliance for household purposes, in particular a fully automatic coffee machine, having such a beverage outlet.

Published, non-prosecuted German patent application DE 102021109252 A1, corresponding to U.S. patent publication No. 2024/0206673, shows an apparatus for preparing a coffee beverage having a brewing unit, to which hot water can be supplied under pressure from a hot water dispenser, and having a beverage outlet, which is connected to the brewing unit via an outlet line and via which the freshly brewed coffee beverage can be dispensed into a drinking vessel to be placed underneath. A return suction pump is provided, which is connected in a fluid-conducting manner on the suction side to the outlet line and which opens on the pressure side into a drain or a collecting container in order to extract coffee beverage from the coffee line before, during or after a brewing process and to guide it into the drain or collecting container.

### SUMMARY OF THE INVENTION

It is the object of the invention to avoid the discharge of residual liquid from a preceding beverage preparation when a beverage is being prepared.

This object is achieved in accordance with the invention in the beverage outlet mentioned in the introduction in that at least one individual outlet differs from the other individual outlet or from the remaining individual outlets in its geometric dimensions in such a manner that all individual outlets are completely emptied.

With the foregoing and other objects in view there is provided, in accordance with the invention, a beverage outlet for a beverage preparation appliance for household purposes. The beverage outlet includes an inlet coming from a preparation apparatus of the beverage preparation appliance. The inlet has a bifurcation which faces away from the preparation apparatus in a direction of flow. At least two individual outlets are connected to the bifurcation in the direction of flow. The at least two individual outlets include at least one first individual outlet which differs from a second individual outlet or from remaining individual outlets in its dimensions, so that all the individual outlets are automatically completely emptied during operation.

Like conventional fully automatic coffee machines, the beverage outlet in accordance with the invention also has an inlet, that is to say a line, which leads the beverage produced in the preparation apparatus, for example in a brewing chamber, to the individual outlets. The inlet directly adjoins the preparation apparatus in the direction of flow of the prepared beverage and opens into a bifurcation, which is connected to individual outlets running parallel to one another. The free ends of the individual outlets facing away from the bifurcation are directed largely vertically downwards onto a storage surface for beverage containers, for example for coffee cups. The individual outlets can be both flexible and inflexible hollow bodies, for example hoses or tubes. The individual outlets can be two or more individual outlets. For the sake of simplicity, the principle is explained below with reference to two individual outlets.

In accordance with the invention, at least one first individual outlet has a geometry that is different from the other, the second individual outlet. The first individual outlet is therefore characterized in accordance with the invention in that it differs from the second individual outlet in terms of its geometric dimensions in such a manner that it can hold another, for example a larger volume of liquid between the bifurcation and its cup-side free end.

During the preparation of the beverage in the exemplary brewing chamber, it passes through the inlet and via the bifurcation into the individual outlets. From there, it flows into the cups provided. At the end of the beverage preparation, a brewing valve closes downstream of the brewing chamber, whereupon neither beverage liquid nor air flows in. As a result, there are still beverage residues or residual liquid in the inlet and in the individual outlets.

The two individual outlets are open at their cup-side end and connected to one another at their other end by the bifurcation downstream of the inlet. In this manner, they represent virtually inverted "communicating tubes". Since the first individual outlet has a higher capacity, it now contains a greater volume of liquid and thus a greater weight of liquid than the second individual outlet. In contrast to equally dimensioned individual outlets, there is therefore an imbalance in the two fluidically coupled individual outlets, namely a higher liquid weight in the first individual outlet. It causes the liquid to leak out of the first individual outlet. When the liquid flows out of the first individual outlet, a hydrostatic pressure is produced, which causes the liquid to be sucked out of the parallel second individual outlet into the first individual outlet, known as the siphon principle. The residual liquid from the second individual outlet therefore also passes through the first individual outlet into the cup. Both individual outlets are thus completely emptied into the cups.

The invention therefore turns away from installing additional systems for ventilating the inlet or for sucking the residual liquids out of the inlet. Rather, it pursues the principle of ensuring the formation of a hydrostatic pressure in a constructively targeted manner at the end of a preparation process. The invention therefore enables a solution that is much simpler in terms of design and therefore more cost-effective and more practicable in terms of production, merely by geometric modification of the individual outlets. Downstream of the brewing valve, the beverage outlet in accordance with the invention thus remains free of interruptions such as internals, valves or ventilation options, but offers a fluidically continuously tight line up to the cup-side free ends of the individual outlets.

The desirable emptying of the beverage outlet downstream of the preparation facility or brewing chamber relates not only to the individual outlets, but also to the inlet supplying them. In an advantageous embodiment of the invention, the bifurcation that guides the beverage into the individual outlets can therefore preferably lie close to the preparation apparatus or the brewing valve. In the ideal case, it can connect fluidically directly to the brewing valve or have a small fluidic distance of a few millimeters in order to keep the inlet as short as possible. This ensures that the beverage outlet downstream of the preparation facility is emptied as completely as possible.

In accordance with the invention, the individual outlets have different geometric dimensions, so that they can contain different volumes. In a further advantageous embodiment of the invention, the individual outlets can differ in that they are of different lengths with the same internal diameter. The length of the individual outlets is measured from the bifurcation to their free cup-side end. The first and the second individual outlet can thus be produced from the previous products known per se, that is to say from the conventional hoses or tubes, wherein they only have to be of different lengths. They can thus be produced as easily as possible without the assembly process having to be changed in a relevant manner.

Different physical forces act on the beverage residues remaining in the individual outlets after the beverage has been dispensed. Thus, the cohesion and adhesion forces acting in the individual outlets as well as the resistance of the line system, i.e. the two individual outlets and the bifurcation, result in a resulting force. The flow direction that is caused by the hydrostatic pressure generated in the beverage outlet in accordance with the invention is in the opposite direction. Therefore, the height difference must exceed a minimum at which the forces acting on the beverage residues are in equilibrium, i.e. equal to zero. In the case of diameters customary for the individual outlets, the height difference is in a range from about 0.8 cm to 0.3 cm, preferably about 0.5 cm.

The unequal length of the individual outlets does not have to be visually apparent at their cup-side free end. This is because the bifurcation is regularly hidden from the user of the beverage preparation device in a housing and can be positioned off-center between the free ends of the individual outlets in accordance with the invention instead of previously in the center.

According to a further advantageous embodiment of the invention, the individual outlets can differ in that they are of different internal diameters with the same length. Externally, the individual outlets do not have to differ in terms of their length in order to be able to enclose different liquid volumes and in order to use the siphon principle for emptying. Since the pressure loss in straight line sections increases as the internal diameter of the line decreases, the internal diameters of the individual outlets are regularly selected such that the pressure drop that occurs in the individual outlets and the capillary effect are overcome.

With the same length of the individual outlets and different internal diameters, the above individual outlets can still be visually distinguished on the basis of their external dimensions with the same wall thickness of their hoses or tubes. According to a further advantageous embodiment of the invention, the individual outlets can be manufactured from materials of different thicknesses. In this manner, the difference in the internal diameters can be concealed in order to make the individual outlets of the same length appear similar on the outside despite different internal diameters.

According to a further advantageous embodiment of the invention, the individual outlets can differ in that they are both of different lengths as well as having different internal diameters. Preferably, the longer individual outlet also has the larger internal diameter, so that the effect of the different dimensions, namely the different internal volume, does not cancel one another out. With suitable dimensions, however, the longer, first individual outlet can also offer the smaller diameter and still a larger volume compared to the second individual outlet. The longer first individual outlet can also have a smaller volume than the second individual outlet if its dimensions, in particular its internal diameter, are suitably selected. The variation of the volume-determining dimensions of the individual outlets can also serve to react to design features or requirements, in particular to a possibly eccentric arrangement of the bifurcation.

In principle, the beverage outlet, i.e. the inlet, the bifurcation and the individual outlets, can be composed of tubes. They offer a high degree of stability. According to a further advantageous embodiment of the invention, at least the individual outlets can comprise hoses. Due to their bendable or flexible material, they can, for example, promote height adjustability of the beverage outlet. In addition, they can offer handling or assembly advantages during manufacture and replacement in the event of repair.

The object mentioned in the introduction is achieved in accordance with the invention in the above-mentioned beverage preparation appliance for household purposes, which comprises a preparation facility, in particular a brewing unit, in that it has an above-described beverage outlet downstream of the preparation facility. As a result, the beverage preparation device can offer the advantages already listed above and, above all, a design that is more structurally simple can be produced more cost-effectively and is less prone to malfunctions.

Other features which are considered as characteristic for the invention are set forth in the appended claims.

Although the invention is illustrated and described herein as embodied in a self-emptying beverage outlet and beverage preparation appliance having a self-emptying beverage outlet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a fully automatic coffee machine according to the prior art; and

FIGS. 2A to 2C are illustrations showing a fully automatic coffee machine in accordance with the invention.

### DETAILED DESCRIPTION OF THE INVENTION

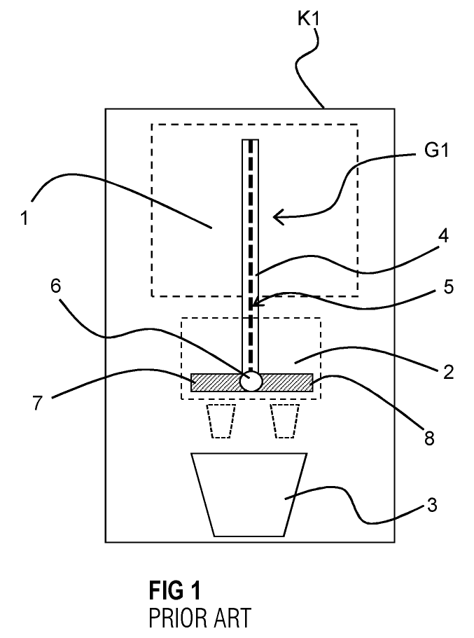

Referring now to the figures of the drawings in detail and first, particularly to FIG. 1 thereof, there is shown a highly schematic view of a fully automatic coffee machine K according to the prior art. From a brewing chamber 1 as a preparation apparatus, a beverage prepared therein passes through a beverage outlet G1 into a cup 3 placed underneath. The beverage outlet G1 contains an inlet 4, which opens into a height-adjustable dispensing unit 2. The inlet 4 branches in a dispensing unit 2 at its downstream end in a bifurcation 6. Connected to the bifurcation 6 are two short individual outlets, a first individual outlet 7 and a second individual outlet 8, which are directed towards the cup 3, which is placed under the dispensing unit 2 of the fully automatic coffee machine.

Residual liquid 5 remains in the inlet 4 and in the short first and second individual outlets 7, 8 after the beverage has been dispensed, because after completion of the beverage preparation, a brewing valve of the brewing chamber 1 closes and therefore neither liquid nor air can flow in and allow the inlet 4 to be emptied. The possibly cooled residual liquid 5 of the previous beverage preparation passes into the new cup 3 at the beginning of a subsequent beverage preparation. Especially in the case of small beverage portions, such as, for example, in the case of espresso, the residual liquid 5 of the previous beverage preparation can have a negative effect on the quality of a beverage prepared subsequently.

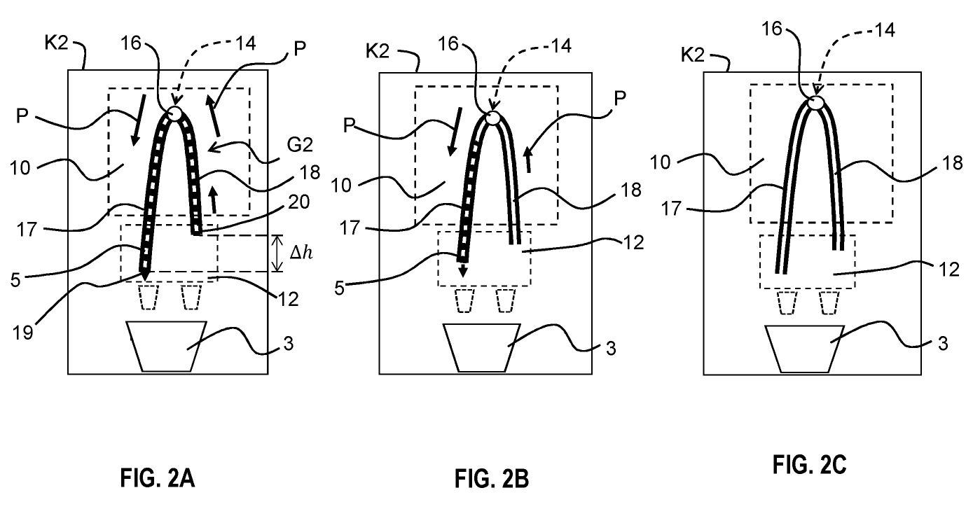

FIGS. 2A to 2C illustrate a highly schematic view of a fully automatic coffee machine K2 in accordance with the invention. A brewing chamber 10 as a preparation apparatus delivers the beverage to an inlet 14 of a beverage outlet G2 in accordance with the invention, which inlet runs perpendicular to the plane of the drawing. The inlet 14 is divided into a bifurcation 16 that faces away from the preparation apparatus 10 in the direction of flow and lies in the plane of the drawing. Downstream of the bifurcation 16, two parallel individual outlets extend up to a dispensing unit 12, namely a first individual outlet 17 and a second individual outlet 18, both of which are directed towards a cup 3.

In contrast to the bifurcation 6 with respect to the dispensing unit 2 of FIG. 1, the bifurcation 16 in accordance with the invention is located much further upstream of the dispensing unit 12 and thus much closer to the brewing chamber 10. This shortens the length of the concealed inlet 14 between the brewing chamber 10 and the bifurcation 16. As a result, the first and second individual outlets 17, 18 are very much longer than in the prior art (see FIG. 1).

A further difference with respect to the prior art is that the first and second individual outlets 17, 18 have a different length: The length of the first and second individual outlets 17, 18 is in each case between their cup-remote end in the bifurcation 16 and a cup-near and free end 19, 20 in the dispensing unit 12. While the first free end 19 of the left-hand side, first individual outlet 17 projects vertically much further down towards the cup 3 into the dispensing unit 12, the second free end 20 of the right-hand side, second individual outlet 18 lies significantly higher above the cup 3. The different height positions of the first and second free ends 19, 20 therefore lead to a length or height difference Δh of the first and second individual outlets 17, 18. The height difference amounts to about 0.4 cm.

After completion of the beverage dispensing, a brewing valve of the brewing chamber 10 closes, so that residual liquid 5 is located in the inlet 14, in the bifurcation 16 and in the first and second individual outlets 17, 18, which initially comes to a standstill there due to the lack of after-flow of liquid or air. The height difference ∆h of the first and second individual outlets 17, 18 now has the effect that, immediately after the beverage has been dispensed, a higher volume of residual liquid 5 is located in the longer, left-hand side and first individual outlet 17 than in the right-hand side, second individual outlet 18. The first and second individual outlets 17, 18 are open at the bottom. Due to the imbalance of the residual liquid 5 in the first and second individual outlets 17, 18, the residual liquid 5 now flows out of the longer first individual outlet 17. In this case, a hydrostatic pressure is generated, which sucks the remaining residual liquid 5 from the right-hand side, second individual outlet 18, which is connected via the bifurcation 16, as well as air from the environment into the second individual outlet 18 (so-called siphon principle). Without further design measures, the residual liquid 5 is therefore conveyed from the right-hand side, second individual outlet 18 via the bifurcation 16 as an apex through the longer, first individual outlet 17 in the direction of the arrows P (FIG. 2A, 2B) into the cup 3 until first and second individual outlets 17, 18 are completely emptied (FIG. 2C).

In accordance with the invention, the bifurcation 16 is arranged very close to the brewing chamber 10, and the inlet 14 is therefore very short. As a result, after the first and second individual outlets 17, 18 have been automatically emptied, no or hardly any residual liquid 5 remains, which could pass into a fresh cup 3 during a subsequent preparation process.

The above hydrostatic pressure is counteracted by physical forces, which are based both on a certain fluidic resistance of the line system from the first and second individual outlets 17, 18 and the bifurcation 16, and on capillary action. The resulting force acts in the opposite direction to the direction of flow indicated by the arrows P in FIGS. 2A, 2B and is dependent, inter alia, on the length, diameter and material of the line system as well as on the physical properties of the residual liquid 5 flowing through the first and second individual outlets 17, 18. In order to overcome the force opposing the direction of flow, the height difference ∆h must be a minimum of about 0.4 to 0.6 cm, depending on the properties of the line system and the fluid.

Since the above beverage outlet described in detail is an exemplary embodiment, it can be modified to a large extent by a person skilled in the art in a conventional manner without departing the scope of the invention. In particular, the specific embodiments of the individual outlets, their number or the position of the bifurcation can also follow in a form other than that described here. The dispensing unit can also be configured in a different form if this is necessary for reasons of space or design. Furthermore, the use of the indefinite article “a” or “an” does not rule out that the relevant features can also be provided multiple times.

The following is a summary list of reference numerals and the corresponding structure used in the above description of the invention:

1 Brewing chamber

2 Dispensing unit

3 Cup

4 Inlet

5 Residual liquid

6 Bifurcation

7 First individual outlet

8 First individual outlet

10 Brewing chamber

12 Dispensing unit

14 Inlet

16 Bifurcation

17 First individual outlet

18 Second individual outlet

19 First free end

20 Second free end

∆h Height difference

G1 Beverage outlet

G2 Beverage outlet

K1 Fully automatic coffee machine

K2 Fully automatic coffee machine

P Arrow

1. A beverage outlet for a beverage preparation appliance for household purposes, comprising:
an inlet coming from a preparation apparatus of the beverage preparation appliance, said inlet having a bifurcation which faces away from the preparation apparatus in a direction of flow; and
at least two individual outlets connected to said bifurcation in the direction of flow, said at least two individual outlets include at least one first individual outlet which differs from a second individual outlet or from remaining individual outlets in its dimensions, so that all said individual outlets are automatically completely emptied during operation.

2. The beverage outlet according to claim 1, wherein said bifurcation lies close to the preparation apparatus.

3. The beverage outlet according to claim 1, wherein said at least one first individual outlet and said second individual outlet differ from each other in that they are of different lengths with a same internal diameter.

4. The beverage outlet according to claim 1, wherein said at least two individual outlets differ from each other in that they have different internal diameters for a same length.

5. The beverage outlet according to claim 4, wherein said at least two individual outlets differ from each other in that they are made of materials of different thicknesses.

6. The beverage outlet according to claim 1, wherein said at least two individual outlets differ from each other in that they are of different lengths and have a different internal diameter.

7. The beverage outlet according to claim 1, wherein said at least two individual outlets contain hoses.

8. The beverage outlet according to claim 1, wherein the beverage preparation appliance is a fully automatic coffee machine.

9. A beverage preparation appliance for household purposes, comprising:
a preparation apparatus; and
the beverage outlet according to claim 1 and disposed downstream of said preparation apparatus.

10. The beverage preparation appliance according to claim 9, wherein the beverage preparation appliance is a fully automatic coffee machine.
